(19) United States
(12) Patent Application Publication
(10) Pub. No.: US 2015/0075347 A1
(43) Pub. Date: Mar. 19, 2015

(54) METHOD FOR PROVIDING AN ABRASION RESISTANT CUTTING EDGE AND TRIMMING DEVICE HAVING SAID CUTTING EDGE

(71) Applicant: Braun GmbH (a German Corporation), Kronberg (DE)

(72) Inventors: Bernd NOOTBAAR, Uelversheim (DE); Klaus EIMANN, Zellingen (DE)

(21) Appl. No.: 14/552,168

(22) Filed: Nov. 24, 2014

Related U.S. Application Data
(63) Continuation of application No. 13/595,253, filed on Aug. 27, 2012, now abandoned.

(30) Foreign Application Priority Data
Aug. 27, 2011 (EP) 11007004.2

(51) Int. Cl. B26D 1/00; A46D 9/02

(52) U.S. Cl. CPC B26D 1/0006; A46D 9/02; B26D 2001/002; B26D 2001/0033; B26D 2001/0066; B26D 2001/006
USPC 83/694

(57) ABSTRACT

A method for manufacturing a toothbrush filament trimmer includes providing a cutter and a counter knife each comprised of hot-working steel, wherein the cutter and the counter knife include at least a recess suitable to carry a coating to form a cutting edge; depositing a first material onto the at least one recess of the cutter and/or the counter knife to form a first layer; depositing a second material onto each first layer to form a second layer, wherein at least a carbide of at least one element of the fourth, the fifth, the sixth and/or the seventh group of the periodic table is used as the second material; and sharpening the coating comprising the first layer and the second layer applied to the at least one recess of the cutter and/or to the at least one recess of the counter knife, wherein a cutting edge is formed.

### CROSS REFERENCE TO RELATED APPLICATIONS

This application claims the benefit of European Patent Convention Application No. 11007004.2, filed Aug. 27, 2011, the substance of which is incorporated by reference in its entirety herein.

### FIELD OF THE INVENTION

The present disclosure is directed to a method for producing an abrasion resistant cutting edge of a toothbrush filament trimming device. More particularly, the present disclosure is directed to a filament trimming device having such an abrasion resistant cutting edge.

### BACKGROUND OF THE INVENTION

A conventional brush, in particular a toothbrush, comprises a brush head and a shaft or a handle. Individual bristle filaments are grouped together to form bristle bundles or bristle tufts which are arranged in a predefined geometry onto the brush head. In some cases, said bristle tufts are fastened by anchors or anchor wires into blind ended tuft holes. For fastening, the tufts are looped or bent in a U-shaped configuration around said anchor wire, said staple or said anchor. Thereby the filament ends protrude from the brush surface in different lengths. Therefore, bristle tufts have to be cut after mounting into the toothbrush head. Trimming machines used for this purpose are intended to cut a huge amount of plastic filaments in a continuous high quality. Quality of the filament cut directly influences the following step of end rounding of the filaments. The better the filaments are cut, the easier the filaments are end rounded. Therefore, cutting tools must be hard and tough and must not bend or flex during machining. Cutters are usually made of steel or steel alloys, wherein hardness of steels depends on the alloy used. However, maximum hardness of steels is limited because increasing the hardness makes the steel more brittle and reduces toughness at the same time.

Further, abrasion will take the edge of the cutters over time such that the sharpness decreases, even though the cutters are made from hard steel. Thus, there is a need for abrasion resistant cutters. Further, harder steels are usually more expensive, but investment costs are a key feature in toothbrush business. Thus, there is also a need to provide an abrasion resistant cutter which is cost effective at the same time.

### SUMMARY OF THE INVENTION

Several embodiments are disclosed in the independent claims to exemplify the subject-matter of the present disclosure. Further embodiments are disclosed by the subject matter of the dependent claims. In accordance with at least one aspect, there is provided a method for manufacturing a toothbrush filament trimmer comprising the steps of providing a cutter and/or a counter knife each comprising hot-working tool steel, wherein the cutter and/or the counter knife comprise at least a recess suitable to carry a coating to form a cutting edge. The method further comprises the step of depositing a first material onto the at least one recess of the cutter and/or the counter knife to form a first layer, and depositing a second material onto each first layer to form a second layer, wherein at least a carbide of at least one element of the fourth, the fifth, the sixth and/or the seventh group of the periodic table is used as the second material. The first layer material may be a powder-metallurgical steel. Finally, the method comprises the step of sharpening the coating comprising the first layer and the second layer applied to the at least one recess of the cutter and/or to the at least one recess of the counter knife, wherein an abrasion resistant cutting edge is formed.

In accordance with another aspect, there is provided a filament trimming device for cutting filaments of a toothbrush comprising a cutter and a counter knife, each comprising at least one cutting edge, wherein the at least one cutting edge of the cutter and the at least one cutting edge of the counter knife are located opposite to each other, and wherein the at least one cutting edge of the cutter and the at least one cutting edge of the counter knife comprise a complementary surface contour, and wherein the at least one cutting edge of the cutter and the at least one cutting edge of the counter knife each comprise at least one recess carrying a coating comprising at least a first layer and a second layer.

In accordance with another aspect, there is provided a method for trimming toothbrush filaments comprising removing at least one filament tuft from a plurality of filaments; then fixing said at least one filament tuft in a tuft hole provided by a brush head or a part of a brush head and finally cutting the free filament ends of the at least one filament tuft using a cutting device. Said cutting device comprises at least one cutting edge which is coated by a first layer and a second layer comprising at least a carbide of at least one element of the fourth, the fifth, the sixth and/or the seventh group of the periodic table so that carbide-cut free filament ends are provided.

These and other features, aspects and advantages of specific embodiments will become evident to those skilled in the art from a reading of the present disclosure.

### BRIEF DESCRIPTION OF DRAWINGS

The embodiments set forth in the drawings are illustrative in nature and not intended to limit the invention defined by the claims. The following detailed description of the illustrative embodiments can be understood when read in conjunction with the following drawings, where like structure is indicated with like reference numerals and in which:

FIG. 1A shows a perspective view of an example cutter according to embodiments shown and described herein;

FIG. 1B shows a top view of the cutter shown in FIG. 1A,

FIG. 1C shows a side view of the cutter shown in FIG. 1A;

FIG. 2A shows a perspective view of an example counter knife according to embodiments shown and described herein;

FIG. 2B shows a top view of the counter knife shown in FIG. 2A;

FIG. 3A shows a perspective view of a cutting section of a trimming device as according to embodiments shown and described herein;

FIG. 3B shows a magnification of the cutting areas of the cutting section shown in FIG. 3A;

FIG. 4 shows schematically the build-up of the coating according to embodiments shown and described herein;

FIG. 5A shows a perspective view of another example cutter according to embodiments as shown and described herein;

FIG. 5B shows a perspective view of another example counter knife according to embodiments as shown and described herein;

FIG. 6A shows a perspective view of another example cutter according to embodiments as shown and described herein;

FIG. 6B shows a perspective view of another example counter knife according to embodiments as shown and described herein;

FIG. 7A shows a perspective view of another example cutter according to embodiments as shown and described herein;

FIG. 7B shows a perspective view of another example counter knife according to embodiments as shown and described herein; and

FIG. 8 shows a brush head of a toothbrush being cut by cutting areas of a cutting section according to embodiments as shown and described herein.

### DETAILED DESCRIPTION OF THE INVENTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

In accordance with at least one aspect of the disclosure, there is provided a method for producing an abrasion resistant cutting edge suitable for trimming filaments of brushes, for example, toothbrushes. The cutting edge may be part of a cutting area of cutting devices such as cutters, knives, mills, mortisers, trimmers, razor blades, electric shavers etc. The main body of the cutting area may be manufactured from hot-working tool steel and may be shaped as protrusions, terraced protrusions, narrowing protrusions or small edges. At the surface of the most protruding part of the cutting area a recess may be formed for carrying an abrasion resistant coating. In one embodiment, the abrasion resistant coating may comprise two layers. A first material may be deposited to the surface of the cutting area as a base layer. Suitable materials which can be used as the base layer are powder-metallurgical steels. A suitable method for depositing the first material may be for example laser cladding. Then, a second material comprising at least particles of carbides of one element of the fourth, the fifth, the sixth and/or the seventh group of the periodic table may be deposited to the first layer. A suitable method for depositing the second material may be, for example, laser cladding. Finally, the resulting coating may be sharpened, forming a sharp cutting edge. Suitable sharpening machines may be, for example, grinding machines.

In one embodiment, the powder-metallurgical steel may comprise Rockwell hardness (HRc-value) in a range of from about 50 to about 60, in another embodiment, from about 55 to about 60; and in yet another embodiment any individual number within the values provided or in any range including or within the values provided. All percentages, ratios and proportions herein are by weight, unless otherwise specified. In addition or alternatively, the second layer may be selected from the group consisting of titanium carbide, niobium carbide, tantalum carbide, chromium carbide, tungsten carbide and mixtures thereof. The example carbides may be provided in a matrix material, wherein matrix material may comprise nickel, cobalt and/or iron. The carbides may be present in the matrix material in an amount of from about 60% to about 80%, in another embodiment in an amount of from about 70% to about 80%, in yet another embodiment in an amount of from about 70% to about 75% or in yet another embodiment any individual number within the values provided or in any range including or within the values provided.

Deposits achieved by laser cladding are metallurgically bound and are perfectly dense, meaning that the coating does not show any porosity. During the laser cladding steps the material of the cutting area as well as the material used for the first and/or second layer may be molten and then cooled, thereby forming a layer of heat treatable abrasion resistant steel alloy, which is metallurgically bonded to the body of the cutting area. The material of the coating may be added as fine powder. The powder may be deposited via a conveyer to the surface of the recess of the cutting edge directly. The laser beam melts the powder and forms a pool of molten cladding material. The laser and the conveyer are moved along the recess to be coated. Molten material left behind by the moving laser beam cools down and solidifies again, but now the coating material is metallurgically bound to the surface of the cutting area forming an abrasion resistant cutting edge.

In one embodiment, the abrasion resistant coating comprising the first and second layer may be applied in one or more depositing steps. The number of cladding repetitions depends on the desired thickness of the resulting layer. If the thickness of the layer is small enough to be deposited once, a single deposition step may be used. If the thickness of the layer is bigger and may not be applicable in one depositing step, two or more deposition steps may be performed, wherein the material of each deposition step is superimposed. In one embodiment, the first and/or second layers may be deposited twice. Up to three times of depositing material to the surface of the cutting area laser cladding can be performed without intermediate cooling of the body to be coated. Up to three times of depositing material to the surface of the first layer laser cladding can be performed without intermediate cooling of said first coating. Generally, the thickness of each sub-layer applied can be adjusted by regulating the amount of deposited material and the velocity of the laser.

According to the disclosed method, a coating should be applied which is sufficiently thick to allow resharpening of the cutting edge. The thicker the second layer is, the more often the abrasion resistant cutting edge can be resharpened. In one embodiment, the thickness of the first layer may be in the range of from about 1 mm to about 4 mm, in another embodiment in the range of from about 1.5 mm to about 3 mm; in another embodiment in the range of from about 2 mm to about 2.5 mm; and in yet another embodiment any individual number within the values provided or in any range including or within the values provided. In addition or alternatively, the thickness of the second layer may be in the range of from about 0.1 mm to about 2 mm, in another embodiment in the range of from about 0.5 mm to about 1.5 mm, in another embodiment in the range of from about 0.8 mm to about 1.2 mm; and in yet another embodiment any individual number within the values provided or in any range including or within the values provided.

In one embodiment, resharpening of the applied coating may be repeated at least about 15 times, in another embodiment at least about 20 times, in another embodiment at least about 25 times, and in yet another embodiment at least about 30 times before a new coating should be deposited onto the cutting edge. For sharpening and/or resharpening, abrasive wheels or grinding machines may be used to shape the deposited coating into a sharp cutting edge. In one embodiment, the coating cannot be resharpened into a sharp cutting edge again. Then, the coating may be removed totally from the cutting area and a new coating comprising at least two layers as described above can be applied. Removing of the residual amount of the abrasion resistant coating may be performed using a grinding machine or abrasive wheels.

Generally, laser cladding may be performed using a power laser emitting a monochromatic coherent light beam. In particular, a laser may be used having enough energy to melt the base metal to be coated as well as the cladding material brought in the form of fine powder. Suitable lasers which can be used are high-power diode lasers, lamp-pumped solid-state lasers, CO₂-lasers or Nd:YAG-lasers. Good results may be achieved, if the laser is used out of focus during laser cladding procedure. According to one embodiment, the laser may be used from about 0.5 mm to about 10 mm out of focus, in another embodiment from about 1 mm to about 8 mm out of focus, and in yet another embodiment from about 2 mm to about 5 mm out of focus; and in yet another embodiment any individual number within the values provided or any range including or within the values provided.

During laser cladding the surface of the cutting area may be melted partially during deposition of the first layer. Thereby, a metallurgic bond can be achieved between the material of the cutting area and the first layer. Thereby, a small transition zone may result comprising material of the cutting area and the first layer. “Metallurgical bond” means that the coating is fused to the surface of the cutting area in such that the microstructure at the base of the coating may be intimately linked to the microstructure of the first layer forming a transition zone.

In addition or alternatively, the surface of the first layer may be melted partially during deposition of the second layer using laser cladding. Thereby, a metallurgic bond can be achieved between the material of the first layer and the material of the second layer and a small transition zone may result comprising material of both layers. “Metallurgical bond” means here that the second layer is fused to the surface of the first layer in such that the microstructure at the base of the second layer may be intimately linked to the microstructure of the first layer forming a transition zone.

In addition or alternatively, the carbide particles may not be molten during laser cladding so that carbide particles as provided may be present in the second layer after forming the coating. Alternatively, the carbide particles may be molten during laser cladding. If the carbide particles melt during laser cladding, the carbide particles solidify again during cooling forming thin dendrites. Alternatively, the carbide particles melt partially during laser cladding so that original particles and solidified dendrites can be found in the second layer.

Due to the two step procedure a very abrasion resistant coating is achieved. The material for the cutting area of the filament trimming device can be chosen in a cost-saving manner, because no special requirements for the body of the cutting area have to be met. The abrasion resistant properties are provided by the applied coating. The applied coating comprises two different layers, namely a base layer and a layer comprising abrasion resistant particles. The first layer which may comprise powder-metallurgic steel provides an abrasion resistant coating itself, but has a lower abrasion resistance than the second layer and thus can be used as base layer or bonding layer for the second layer. However, elasticity of the coating decreases, when abrasion resistance increases, meaning that a coating which shows a high abrasion resistance may also show the formation of cracks. The cracks are usually a result of tension due to different material properties of the main body and the coating. By depositing the second layer comprising carbide particles on top of the first layer as disclosed herein, the number of cracks is reduced. The first layer forms an ideal intermediate layer having a sufficient abrasion resistance to be a hard basis for the second layer and at the same time being elastic enough to avoid the formation of cracks. Thereby, materials having a huge amount of carbide particles can be used as second layer. Thus, the method disclosed provides a very abrasion resistant coating which does not show cracks in the surface during use.

According to another aspect, there is provided a trimming device for cutting filaments of a toothbrush having at least one cutting edge which is coated as described above. In one embodiment, the cutting edge of the at least one trimming device comprises a coating having at least a first layer and a second layer. The first layer may comprise or may consist of a powder-metallurgical steel and the second layer may comprise at least abrasion resistant particles. The abrasion resistant particles may comprise at least carbides of at least one element of the fourth, the fifth, the sixth and/or the seventh group of the periodic table. All features, whether described in combination or individually, which are described in combination with the coating shall be applicable as well to the coating of the trimming device.

In one embodiment, the trimming device may have a cutter and/or a counter knife, wherein each may have a coated cutting edge. For example, the cutter may be a rotating cutter or guillotine cutter. In addition or alternatively, the counter knife may be a counter cutter working itself as cutting device and thus having a cutting edge. Alternatively, the counter knife may be only a counter surface which does not show any cutting activity.

The cutter and the counter knife may be arranged in the trimming device such that the at least one cutting edge of the cutter and the at least one cutting edge of the counter knife are located opposite to each other. In one embodiment, the cutter and the counter knife are arranged such that a gap is provided between the cutting edge of the cutter and the cutting edge of the counter knife. The gap may be in the range of from about 0.001 mm to about 0.1 mm, in another embodiment in the range of from about 0.003 mm to about 0.05 mm, in another embodiment in the range of from about 0.005 mm to about 0.01 mm, and in yet another embodiment any individual number within the values provided or any range including or within the values provided.

In addition or alternatively, the cutter and the counter knife may comprise a complementary surface contour. The cutting edge may comprise any surface contour which can be ground. The limitation for grinding is the diameter and/or the thickness of the grinding device. In one embodiment, the minimal corner radius of the curvature of the surface contour of the cutting edge is less than about 0.5 mm, in another embodiment less than about 0.3 mm, and in yet another embodiment less than about 0.15 mm For example, the surface contour may be a curved shape, a convex shape, a concave shape, a wavelike shape, a polygonal shape, a zigzag shape, a chamfered shape and/or any combination thereof. In another embodiment, the surface contour is a straight line. Examples for complementary surface contours are cutters having a convex surface contour being combined with a counter knife having a concave surface contour. Alternatively, two convex surface contours having a different radius can be combined as well. As another example, zigzag or wavelike shapes can be shifted to achieve a complementary profile on the surface of the cutter and the counter knife.

According to another aspect, there is provided a cutting device for cutting animal fibers, such as hairs. In particular, there is provided a cutting device for cutting hair of the beard, hair of the head and/or body hair. In one embodiment, the cutting device may be an electric shaver or a razor. Electric shavers or razors may comprise razor blades comprising at least one cutting edge which is coated as described above. In one embodiment, the cutting edge of the at least one cutting device comprises a coating having at least a first layer and a second layer. The first layer may comprise a powder-metallurgical steel and the second layer may comprise at least abrasion resistant particles. The abrasion resistant particles may comprise at least carbides of at least one element of the fourth, the fifth, the sixth and/or the seventh group of the periodic table. All features, whether described in combination or individually, which are described in combination with the coating shall be applicable as well to the coating of the cutting device.

According to another aspect, there is provided a method of trimming filaments for brushes, for example tooth brushes. The method may comprise providing a trimming device as disclosed herein and using said trimming device for cutting filaments. A trimming device may be used for trimming filaments, comprising all features disclosed herein, whether described individually or in combination.

In one embodiment, the method for trimming toothbrush filaments may comprise the steps of removing and/or picking at least one filament tuft from a plurality of filaments. Then the at least one filament tuft is fixed and/or mounted into a tuft hole which is provided by a brush head or a part of a brush head and finally the free filament ends of the at least one filament tuft are cut using a cutting device as disclosed herein. The cutting device may comprise at least one cutting edge which is coated by a first layer which may comprise a powder-metallurgical steel and a second layer comprising at least a carbide of at least one element of the fourth, the fifth, the sixth and/or the seventh group of the periodic table so that carbide-cut free filament ends are provided.

“Removing and/or picking” as used herein shall mean any form of isolating a number of filaments from a bigger number of filaments and transferring the isolated number of filaments to a separate place. “Fixed and/or mounted” as used herein shall mean that the filament tuft is located in the tuft hole by fixing means. Suitable fixing means may be, for example, clamping means, attaching means or gluing means. “Tuft hole” as used herein shall mean any blind hole or through hole of any form which is located in a brush head, a brush head section, a brush head carrier or a part thereof. In one embodiment, the filament tuft is stapled using an anchor, in another embodiment the tuft is clamped into and/or fused to a carrier plate, and in another embodiment the tuft is over-molded with plastic material.

In addition, the carbide-cut free filament ends may be end-rounded after cutting. Carbide-cut filament ends can be end-rounded easier and to a higher quality, due to the high quality of the cut. Carbide-cut filaments show very similar cutting lines and less frazzling at the free ends. At least about 1,000,000 brush heads, in another embodiment at least about 1,500,000 brush heads, and in another embodiment at least about 3,000,000 brush heads can be cut as disclosed herein without a decrease in the quality of the cut.

In one embodiment, the final length of at least one filament in the filament tuft may differ from the final length of at least one other filament in the filament tuft after cutting. That means, that a surface contour being different from a flat plane can be cut using the cutting device as disclosed herein. In another embodiment, one bristle tuft is cut to one filament length so that a flat plane is achieved. In addition or alternatively, two or more filament tufts may be cut in such that the final length of at least one of the two or more filament tufts is different to the final length of the at least other filament tuft. That means, that a surface contour of a brush head being different from a flat plane can be cut using the cutting device as disclosed herein. The surface profile may have a curved shape, a convex shape, a concave shape, a wavelike shape, a polygonal shape, a zigzag shape, a chamfered shape, or a combination thereof. In another embodiment, all bristle tufts of a brush head are cut to one filament length so that a flat plane is achieved. Cutting of a surface profile may be performed in a single cutting step. If the cutting shall be performed in one cutting step, the surface contour of the cutting edge of the cutting device corresponds to the surface contour of the brush head after cutting. Two or more cutting steps can be performed successively with the same surface profile, thereby increasing the accurateness of the profile cut. Alternatively, cutting of the filaments may be performed in two or more cutting groups. Thereby, a first group of filaments is cut first. Then the cut filaments are bent away and a second group of filaments is cut and bent away and so on.

In the following, a detailed description of several example embodiments will be given. It is noted that all features described in the present disclosure, whether they are disclosed in the previous description of more general embodiments or in the following description of example embodiments, even though they may be described in the context of a particular embodiment, are of course meant to be disclosed as individual features that can be combined with all other disclosed features as long as this would not contradict the gist and scope of the present disclosure. In particular, all features disclosed for either one of the cutter or the counter knife may also be applied to the other one.

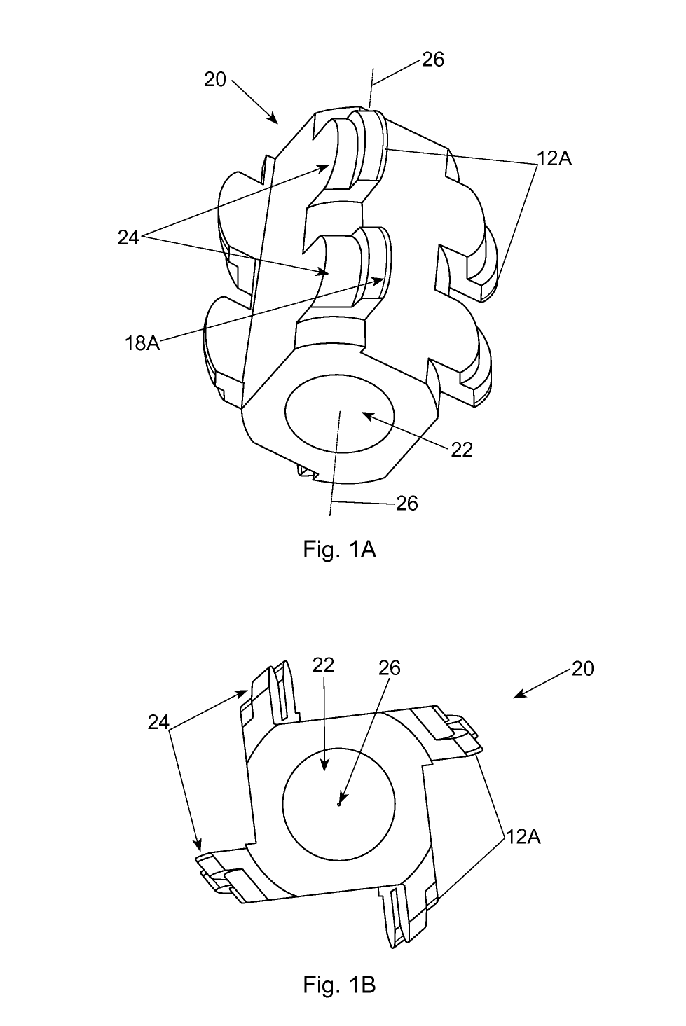

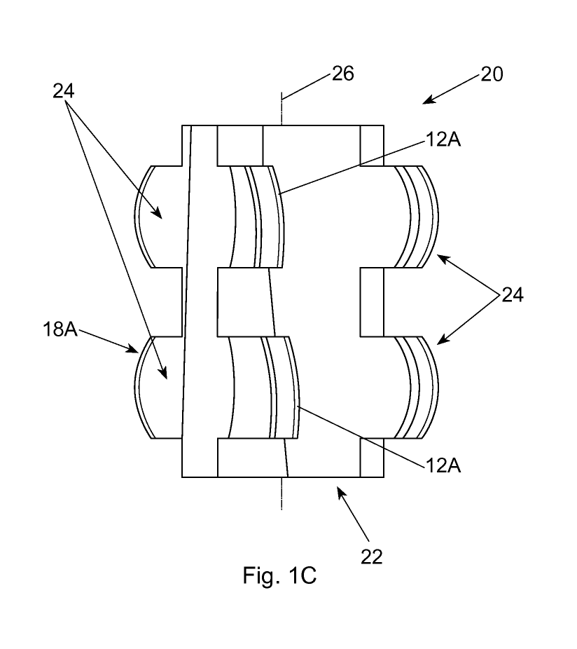

FIGS. 1A to 1C show an example embodiment of a cutter 20 according to the present disclosure. FIG. 1A shows the cutter 20 in a perspective view. FIG. 1B shows a top view and FIG. 1C shows a side view of the cutter 20. In one embodiment, the cutter 20 may have an elongated rectangular main body having a cylindrical hole representing a mounting area 22. The mounting area 22 may be arranged along a longitudinal axis 26 of the cutter 20. The cutter 20 may be attached to a filament trimming device 10 by the mounting area 22 in a conventional manner. For example, a drive rod can be placed into the mounting area 22 for driving the cutter 20 circularly (not shown). At four edges being in parallel to the longitudinal axis 26 one or more cutting areas 24 may be arranged. The cutter 20 shown in FIG. 1 comprises two cutting areas 24 at each of the edges of the main body of the cutter 20 which are located in a single-plane. The cutting areas 24 may be shaped as terraced protrusions. The most protruding protrusion may be narrowed to a small edge representing the cutting edge 12A.

Each cutting edge 12A may be covered by an abrasion resistant coating. To place the coating durably, the most protruding protrusion may comprise a recess 18. The recess 18A may be shaped to carry the abrasion resistant coating totally to form a sharp cutting edge 12A. The dimensions of the recess 18A are adapted to completely fit to the dimensions of the coating so that after deposition of the coating a surface is achieved which does not show any rough edges. The cutting edge 12A may have a surface shape which differs from a straight line. The cutting edge 12A shown in FIG. 1 shows a convex surface contour.

The cutter 20 may be formed by any hard material, for example, steel. Due to the abrasion resistant coating no requirements have to be met by the material of the cutter 20. In one example embodiment, the cutter 20 may be formed from hot-working tool steel or from tool steel, wherein any hot-working tool steel or any tool steel can be used. In particular, the cutter 20 may consist of X37CrMoV5-1 steel. The abrasion resistant coating may be applied by laser cladding as described above. In one embodiment, two layers of different material may be deposited to each of the cutting edges 12A of the cutter 20. A first layer 14 may comprise powder-metallurgical steel. A second layer 16 may comprise at least abrasion resistant particles, for example, carbide particles of elements of the fourth, the fifth, the sixth and/or the seventh group of elements of the periodic table. A detailed description of the first layer 14 and the second layer 16 is given in connection with FIG. 4. All features disclosed in FIG. 4, whether described individually or in combination and which relate to the coating are also applicable to the coating of the cutter 20 shown in FIG. 1.

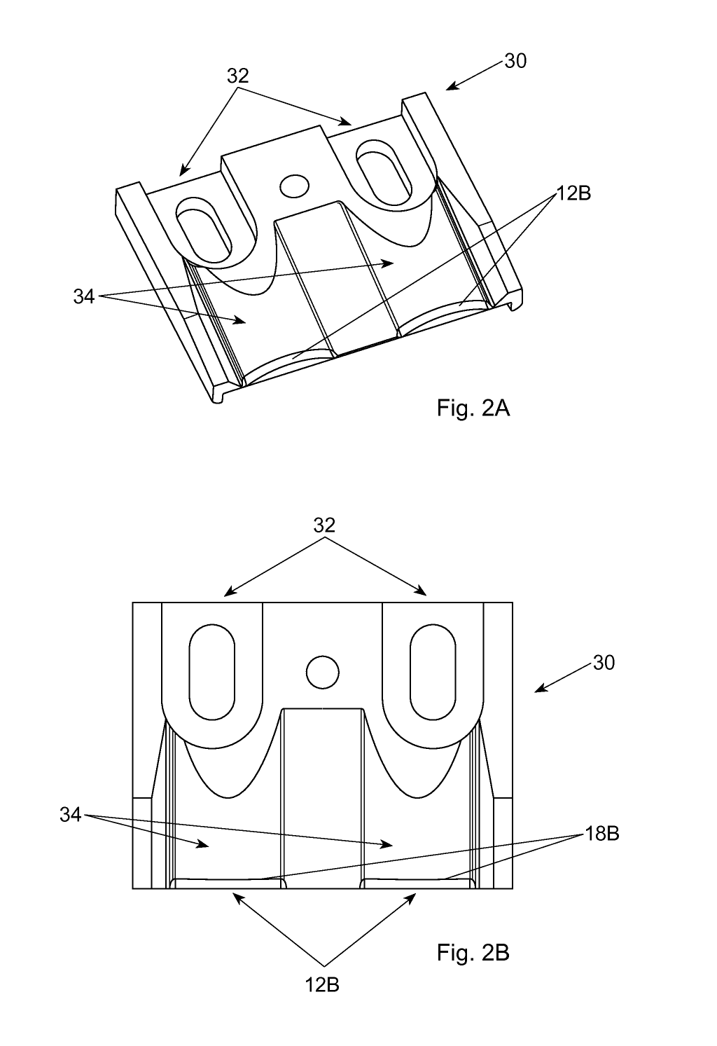

FIGS. 2A and 2B show an example embodiment of a counter knife 30. FIG. 2A shows the counter knife 30 in a perspective view and FIG. 2B shows a top view of the counter knife 30. In this embodiment, the counter knife 30 may have a rectangular and flat main body. At one of the longer sides of the rectangular body mounting areas 32 may be arranged suitable to mount the counter knife 30 to a part of a trimming device 10 in a conventional manner (not shown). For example, two or more mounting areas 32 may be arranged at one side of the rectangular main body of the counter knife 30. Opposite to the mounting areas 32, in particular at another side of the main body of the counter knife 30 one or more cutting areas 34 may be arranged. The counter knife 30 shown as an example in FIG. 2 comprises two cutting areas 34 which may be shaped as elongated protrusions. The cutting areas are located adjacent to each other along one side of the counter knife 30. The most protruding end of the elongated protrusion may be narrowed to a small edge representing the cutting edge 12B. The cutting edges 12B are arranged in one single-plane.

Each cutting edge 12B is covered by an abrasion resistant coating. To place the coating durably, each most protruding part of the cutting area 34 comprises a recess 18B which is suitable to carry the coating. The dimensions of the recess 18B are adapted to completely fit to the dimensions of the coating so that after deposition of the coating a surface is achieved which does not show any rough edges. The cutting edge 12B may have a surface shape which differs from a straight line. The cutting edge 12B shown in FIG. 2 comprises a convex surface contour.

The counter knife 30 may be formed by any hard material, for example, steel. Due to the abrasion resistant coating no requirements have to be met by the material of the counter knife 30. In one example embodiment, the counter knife 30 may be formed by hot-working tool steel or tool steel, wherein every hot-working tool steel or tool steel can be used. In particular, the counter knife 30 may consist of X37CrMoV5-1 steel. The abrasion resistant coating is applied by laser cladding as described above. In one embodiment, two layers of different material may be deposited to each of the cutting edges 12B of the counter knife 30. A first layer 14 may comprise powder-metallurgical steel. A second layer 16 comprises at least abrasion resistant particles, for example carbide particles of elements of the fourth, the fifth, the sixth and/or the seventh group of elements of the periodic table. A detailed description of the first layer 14 and the second layer 16 is given in connection with FIG. 4. All features disclosed in FIG. 4, whether described individually or in combination and which relate to the coating, are also applicable to the coating of the counter knife 30 shown in FIG. 2.

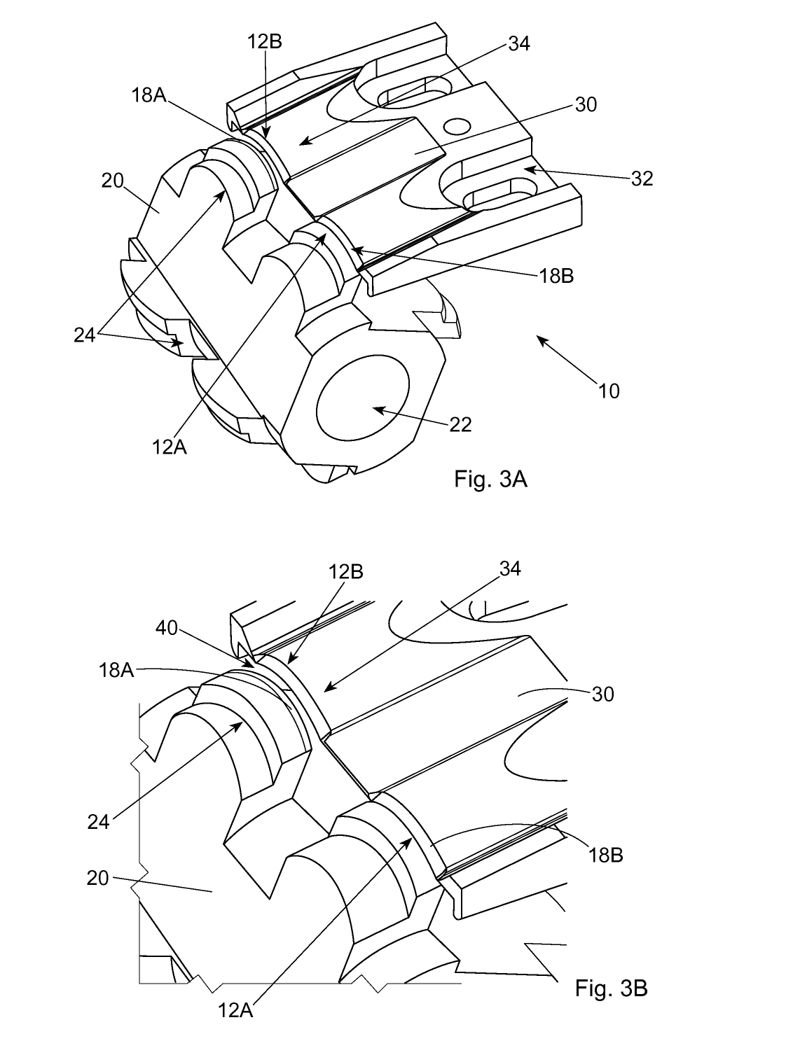

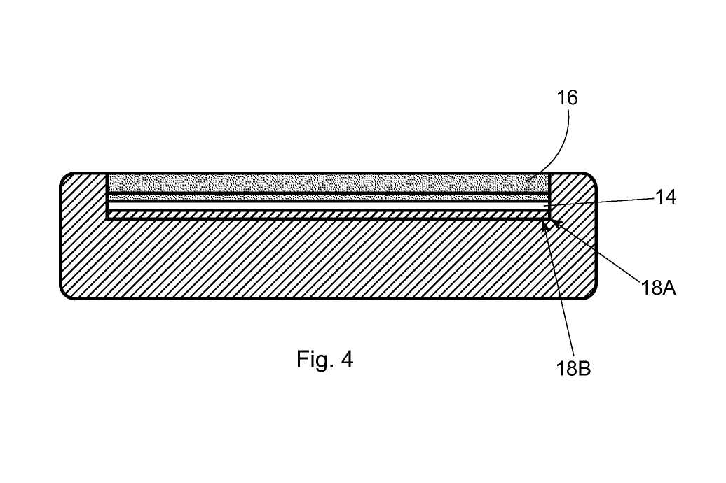

In FIG. 3, a cutter 20 and a counter knife 30 are shown in working position as an example embodiment. FIG. 3A shows a rotating cutter 20 and the counter knife 30 as a whole. FIG. 3B shows a magnification of the cutting areas 24, 34. The cutting edge 12A of the cutter 20 comprises a convex surface contour and the cutting edge 12B of the counter knife 30 comprises a convex surface contour which is complementary to the surface contour of the cutting edge 12A of the cutter 20 regarding size and shape. All features of the cutter 20 and the counter knife 30 disclosed in the embodiments shown in FIGS. 1 and 2, whether described individually or in combination, are also applicable to the embodiment shown in FIG. 3. The same reference signs are used for the same features as used before in FIGS. 1 and 2.

The cutting area 24 of the cutter 20 and the cutting area 34 of the counter knife 30 may be arranged opposite to each other in such that the cutting edges 12A, 12B nearly contact each other in the working position. “Nearly contact” as used herein shall mean that a small gap 40 may be arranged between the cutting edge 12A of the cutter 20 and the cutting edge 12B of the counter knife 30. The size of the gap may be in the range of about 0.001 mm to about 0.1 mm, in another embodiment in the range of about 0.003 mm to about 0.05 mm, and in another embodiment in the range of about 0.005 mm to about 0.01 mm. Using the mounting area 22 the cutter 20 may be connected to a drive rod driving the cutter 20 circularly. Drive rod and further parts of the trimming device 10 are not shown. The counter knife 30 may be connected to another part of the trimming device 10 via the mounting areas 32. Mounting to the trimming device 10 may be performed in such that position and movement of the cutter 20 and the counter knife 30 can be adjusted individually.

A rotating cutter 20 having more than one cutting area 24 may be advantageous in order to achieve a high efficacy of the trimming device 10. The cutter 20 shown in FIG. 3 as an example comprises four pairs of cutting areas 24 which may be arranged equally over the outline of the cutter 20. In the embodiment shown, four pairs of cutting areas 24 are arranged along the edges of the cutter 20. Said pairs of cutting areas 24 may be arranged in such that two cutting areas 24 nearly contact two cutting areas 34 of the counter knife 30 simultaneously during rotation of the cutter 20.

FIG. 3B shows a magnification of the cutting areas 24, 34. The coating is shown at one of the two cutting edges 12A of the cutter 20. At the other cutting area 24 the recess 18A is visualized. At the cutting area 34 of the counter knife 30 one recess 18B and one cutting edge 12B having the abrasion resistant coating are shown. In an example embodiment of the disclosure, both cutting edges 12A, 12B may be coated.

FIG. 4 shows a build-up of the coating which is deposited to the recesses 18A, 18B of the cutting edges 12A, 12B schematically. The features disclosed herein regarding the coating are disclosed generally and are applicable to all embodiments shown. The coating comprises at least a first layer 14 and a second layer 16. Both layers 14, 16 are deposited successively onto recesses 18A, 18B provided in a cutting area 24, 34 of a cutter 20 or a counter knife 30 using laser cladding. In addition, the first layer 14 and/or the second layer 16 may be applied in one or more depositing steps depending on the desired thickness of the resulting layer. In one embodiment, the first layer 14 may comprise a thickness in the range of about 1 mm to about 4 mm, in another embodiment in the range of about 1.5 mm to about 3 mm, in another embodiment in the range of about 2 mm to about 2.5 mm, and in another embodiment any individual number within the values provided or in any range including or within the values provided. In addition or alternatively, the second layer 16 may comprise a thickness in the range of about 0.1 mm to about 2 mm, in another embodiment in the range of about 0.5 mm to about 1.5 mm, in another embodiment in the range of about 0.8 mm to about 1.2 mm, and in another embodiment any individual number within the values provided or in any range including or within the values provided. A thickness in the given ranges can be applied in one deposition step. Thereby, the thickness of the layer can be adjusted by regulating the amount of deposited material and the velocity of the laser. Generally, a coating should be applied which is sufficiently thick to allow resharpening of the cutting edge 12A, 12B. The thicker the second layer 16, the more often the abrasion resistant cutting edge 12A, 12B can be resharpened. In one embodiment, the second layer 16 is thicker than the first layer 14. In addition or alternatively, the second layer 16 may be applied in more than one deposition steps.

In one example embodiment, the cutting edge 12A, 12B may be formed by a hot-working tool steel or a tool steel, wherein every hot-working tool steel or tool steel can be used. Optionally, the cutting edge 12A, 12B may be manufactured from X37CrMoV5-1 steel.

In addition or alternatively, the first layer 14 may comprise powder-metallurgical steel. Said powder metallurgical steel optionally may comprise a Rockwell hardness (HRc-value) in a range of about 50 to about 60, in another embodiment in a range of about 55 to about 60, and in another embodiment any individual number within the values provided or in any range including or within the values provided. Powder-metallurgical steels which may be used are for instance CPM steels available for example from Crucible Industries LLC, 440C-steel, Vanadis23-steel, D2-steel, H19-steel, S7-steel, A2-steel, 1.4125-steel, 1.2379-steel or 1.2767-steel. Suitable CPM-steels are for example CPM S90V, CPM 9V or CPM 1V. In one embodiment, the powder-metallurgical steels may be deposited as a powder comprising particles of several shapes and/or sizes.

In addition or alternatively, the second layer 16 comprises abrasion resistant particles for example carbides of at least one element of the fourth, the fifth, the sixth and/or the seventh group of the periodic table. Suitable carbides from the fourth group may be titanium carbide, zirconium carbide, hafnium carbide or a mixture thereof. Suitable carbides from the fifth group may be vanadium carbide, niobium carbide, tantalum carbide or a mixture thereof. Suitable carbides from the sixth group may be chromium carbide, molybdenum carbide, tungsten carbide or a mixture thereof. Suitable carbides from the seventh group may be manganese carbide, rhenium carbide or a mixture thereof. Carbides of several groups can be used individually or as a mixture. In one embodiment, titanium carbide, niobium carbide, tantalum carbide, chromium carbide, tungsten carbide or a mixture thereof is used. The carbides may be deposited as a powder comprising particles of several sizes and/or shapes.

In addition, the carbides may be applied in a matrix. Suitable matrix components comprise other metals, such as elements of the eighth, the ninth, the tenth or the eleventh group of the periodic table. In one embodiment, iron, cobalt, nickel, copper or a mixture thereof may be used as matrix components. The matrix components may be mixed with the carbides before applying both components as second layer 16 to the first layer 14. In one embodiment, the second layer 16 may comprise carbides in the matrix components in an amount of about 60% to about 80%, in another embodiment in an amount of about 70% to about 80%, in another embodiment in an amount of about 70% to about 75% and in another embodiment in an amount of any individual number within the values provided or in any range including or within the values provided.

In one embodiment, the surface of the recess 18A, 18B provided at the cutting edge 12A, 12B of the cutting areas 24, 34 may be molten partially during deposition of the first layer 14 using laser cladding. Thereby, a metallurgic bond can be achieved between the material of the cutting area 24, 34 and the first layer 14 and a small transition zone results comprising material of the cutting area 24, 34 and the first layer 14. Said transition zone is small enough that the first layer 14 comprising the powder-metallurgical steels remains. In addition or alternatively, the surface of the first layer 14 may be molten partially during deposition of the second layer 16 to the first layer 14 using laser cladding. Thereby, a metallurgic bond can be achieved between material of the first layer 14 and material of the second layer 16, and a small transition zone results comprising material of the first layer 14 and of the second layer 16. Said transition zone is small enough that the first layer 14 which may comprise powder-metallurgical steels and the second layer 16 comprising carbide particles in a metal matrix remain distinguishable in the applied coating.

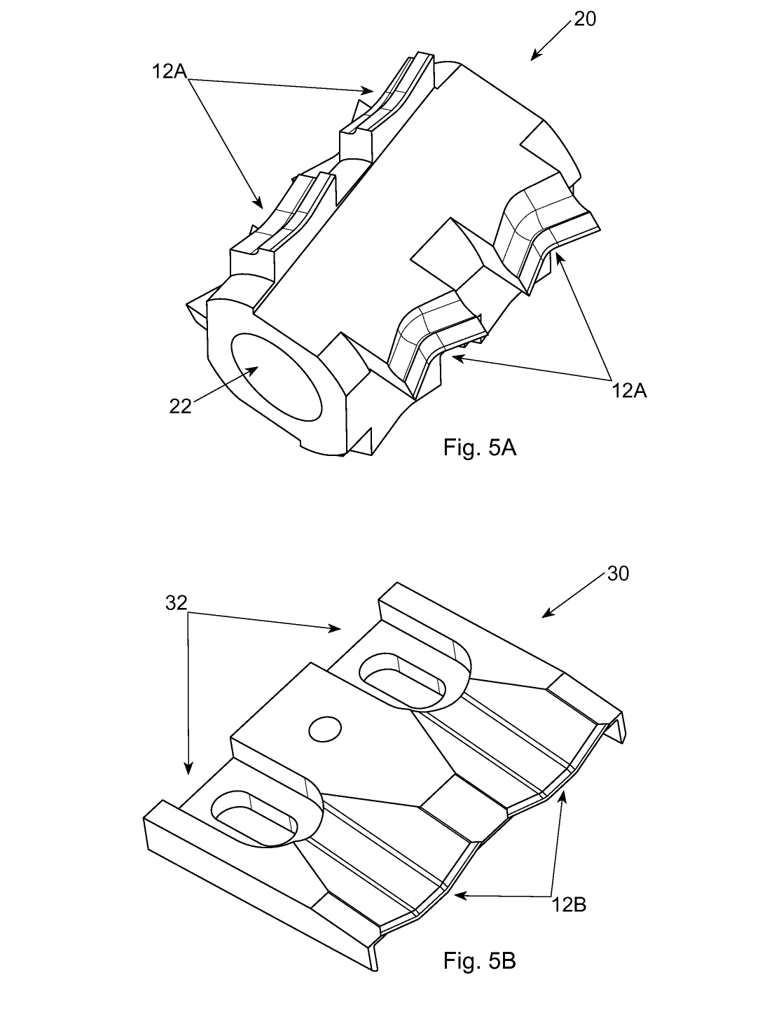

FIG. 5A shows a perspective view of another example cutter 20. The same reference signs are used for the same features as used before in FIGS. 1 to 4. A rotating cutter 20 is shown having eight cutting areas 24 which are arranged in pairs along the surface of the cutter 20. Each cutting area 24 comprises a cutting edge 12A having a buckled concave surface contour. An abrasion resistant coating may be applied to the cutting edge 12A. Said coating may comprise two layers of different materials. A first layer 14 may comprise, for instance, powder-metallurgical steel and a second layer 16 may comprise at least abrasion resistant particles, for example, carbide particles of elements of the fourth, the fifth, the sixth and/or the seventh group of elements of the periodic table. A detailed description of the first layer 14 and the second layer 16 is given in connection with FIG. 4. All features disclosed in FIG. 4, whether described individually or in combination and which relate to the coating, are also applicable to the coating of the cutter 20 shown in FIG. 5A.

FIG. 5B shows a perspective view of another example counter knife 30. The same reference signs are used for the same features as used before in FIGS. 1 to 4. A counter knife 30 is shown having two cutting areas 34 which are arranged as pairs along one side of the counter knife 30. Each cutting area 34 comprises a cutting edge 12B having a buckled convex surface contour. An abrasion resistant coating may be applied to the cutting edge 12B. The coating may comprise two layers of different materials. For example, a first layer 14 may comprise powder-metallurgical steel and a second layer 16 may comprise at least abrasion resistant particles, for example, carbide particles of elements of the fourth, the fifth, the sixth and/or the seventh group of elements of the periodic table. A detailed description of the first layer 14 and the second layer 16 is given in connection with FIG. 4. All features disclosed in FIG. 4, whether described individually or in combination and which relate to the coating, are also applicable to the coating of the counter knife 30 shown in FIG. 5B. All features of the cutters 20 and the counter knives 30 which are disclosed in the embodiments shown in FIGS. 1 to 3 are also applicable to the embodiment shown in FIGS. 5A and 5B, independent of being described individually or in combination.

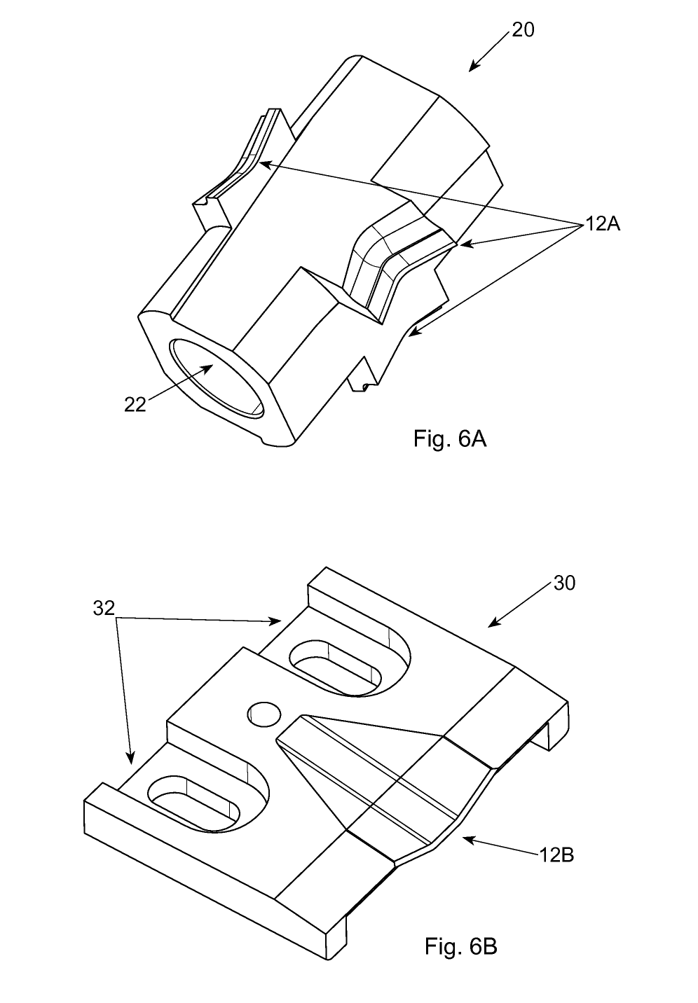

FIG. 6A shows a perspective view of another example cutter 20. The same reference signs are used for the same features as used before in FIGS. 1 to 5. A rotating cutter 20 is shown having four cutting areas 24 which are arranged around the outline of the cutter 20. The cutting areas 24 are arranged in the middle of the cutter 20. Each cutting area 24 comprises a cutting edge 12A having a buckled concave surface contour. An abrasion resistant coating may be applied to the cutting edge 12A. The coating may comprise two layers of different materials. For example, a first layer 14 may comprise powder-metallurgical steel and a second layer 16 may comprise at least abrasion resistant particles, for example carbide particles of elements of the fourth, the fifth, the sixth and/or the seventh group of elements of the periodic table. A detailed description of the first layer 14 and the second layer 16 is given in connection with FIG. 4. All features disclosed in FIG. 4, whether described individually or in combination and which relate to the coating, are also applicable to the coating of the cutter 20 shown in FIG. 6A.

FIG. 6B shows a perspective view of another example counter knife 30. The same reference signs are used for the same features as used before in FIGS. 1 to 5. A counter knife 30 is shown having only one cutting area 34 which is arranged in the middle of one edge of the counter knife 30. The cutting area 34 comprises a cutting edge 12B having a buckled convex surface contour. An abrasion resistant coating may be applied to the cutting edge 12B. Said coating may comprise two layers of different materials. For example, a first layer 14 may comprise powder-metallurgical steel and a second layer 16 may comprise at least abrasion resistant particles, for example, carbide particles of elements of the fourth, the fifth, the sixth and/or the seventh group of elements of the periodic table. A detailed description of the first layer 14 and the second layer 16 is given in connection with FIG. 4. All features disclosed in FIG. 4, whether described individually or in combination and which relate to the coating, are also applicable to the coating of the counter knife 30 shown in FIG. 6B. All features of the cutters 20 and the counter knives 30 which are disclosed in the embodiments shown in FIGS. 1 to 3 are also applicable to the embodiment shown in FIGS. 6A and 6B, independent of being described individually or in combination.

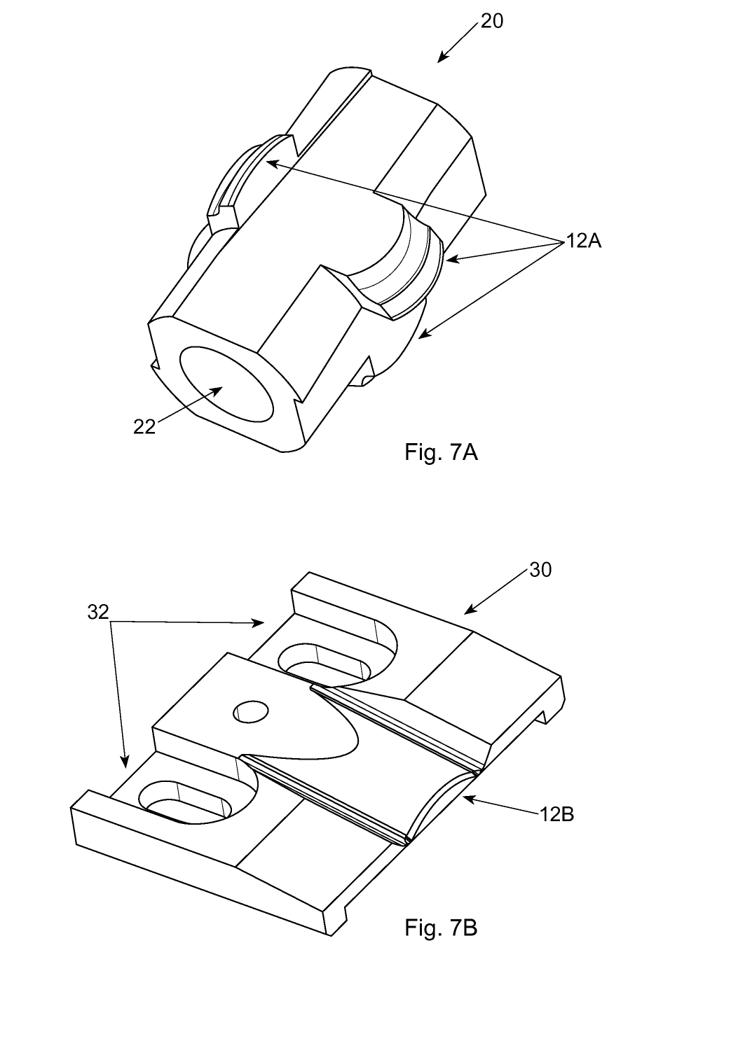

FIG. 7A shows a perspective view of another example cutter 20. The same reference signs are used for the same features as used before in FIGS. 1 to 6. A rotating cutter 20 is shown having four cutting areas 24 which are arranged around the outline of the cutter 20. Further, the cutting areas 24 are arranged in the middle of the cutter 20. Each cutting area 24 comprises a cutting edge 12A having a convex surface contour. An abrasion resistant coating may be applied to the cutting edge 12A. The coating may comprise two layers of different materials: For example, a first layer 14 which is a base layer and which may comprise powder-metallurgical steel and a second layer 16 which may comprise at least abrasion resistant particles, for example, carbide particles of elements of the fourth, the fifth, the sixth and/or the seventh group of elements of the periodic table. A detailed description of the first layer 14 and the second layer 16 is given in connection with FIG. 4. All features disclosed in FIG. 4, whether described individually or in combination and which relate to the coating, are also applicable to the coating of the cutter 20 shown in FIG. 7A.

FIG. 7B shows a perspective view of another example counter knife 30. The same reference signs are used for the same features as used before in FIGS. 1 to 6. A counter knife 30 is shown having only one cutting area 34 which is arranged in the middle of one edge of the counter knife 30. The cutting area 34 comprises a cutting edge 12B having a convex surface contour. An abrasion resistant coating may be applied to the cutting edge 12B. The coating may comprise two layers of different material: For example a first layer 14 being a base layer and which may comprise a powder-metallurgical steel and a second layer 16 which may comprise at least abrasion resistant particles, for example, carbide particles of elements of the fourth, the fifth, the sixth and/or the seventh group of elements of the periodic table. A detailed description of the first layer 14 and the second layer 16 is given in connection with FIG. 4. All features disclosed in FIG. 4, whether described individually or in combination and which relate to the coating, are also applicable to the coating of the counter knife 30 shown in FIG. 7B. All further features of the cutters 20 and the counter knives 30 which are disclosed in the embodiments shown in FIGS. 1 to 3 are also applicable to the embodiment shown in FIGS. 7A and 7B, independent of being described individually or in combination.

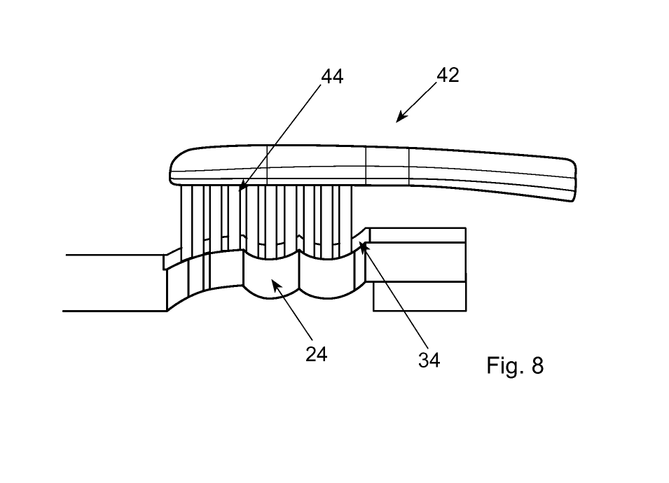

FIG. 8 shows the cutting of bristle filaments 44 of a brush head 42. The bristle filaments 44 are cut by a cutting device 10 as disclosed herein. Two cutting edges 24, 34 having a complementary surface contour are cutting the filament ends like scissors. The resulting surface contour of the brush head 42 corresponds directly to the surface contour of the two cutting edges 24, 34.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A filament trimming device for cutting filaments of a toothbrush comprising:
a cutter in combination with a counter knife, wherein each of the cutter and the counter knife comprises hot-working steel and includes at least one cutting edge,
wherein the at least one cutting edge comprises a coating including at least a first layer and a second layer comprising at least a carbide of at least one element of the fourth group, the fifth group, the sixth group and/or the seventh group of the periodic table,
wherein at least one of the cutter and the counter knife includes a recess formed adjacent to the cutting edge thereof, said recess being shaped to carry the abrasion-resistant coating totally to form a sharp cutting edge, and wherein said recess has dimensions to completely fit the coating so that a surface of the cutting edge have no rough edges thereon.

2. The filament trimming device according to claim 1, wherein the first layer comprises a powder-metallurgical steel having a Rockwell hardness (HRc-value) in a range of from about 50 to about 60.

3. The filament trimming device according to claim 1, wherein the second layer comprises titanium carbide, niobium carbide, tantalum carbide, chromium carbide, tungsten carbide or a mixture thereof.

4. The filament trimming device according to claim 1, wherein the second layer comprises nickel, cobalt and/or iron.

5. The filament trimming device according to claim 1, wherein the second layer comprises the carbide in an amount of from about 60% to about 80%.
